(19) United States
(12) Patent Application Publication
(10) Pub. No.: US 2025/0078246 A1
(43) Pub. Date: Mar. 6, 2025

(54) INFORMATION PROCESSING APPARATUS, METHOD FOR CONTROLLING SAME, AND STORAGE MEDIUM

(71) Applicant: CANON KABUSHIKI KAISHA, Tokyo (JP)

(72) Inventor: TAKUYA INOUE, Ibaraki (JP)

(21) Appl. No.: 18/815,954

(22) Filed: Aug. 27, 2024

(30) Foreign Application Priority Data
Aug. 29, 2023 (JP) 2023-139122

(51) Int. Cl. G06T 7/00; G06T 3/40; G06T 3/60; G06V 30/19; H04N 1/00

(52) U.S. Cl. CPC G06T 7/0008; G06T 3/40; G06T 3/60; G06V 30/19093; H04N 1/00029; H04N 1/00087; G06T 2207/30144

(57) ABSTRACT

Disclosed is an information processing apparatus comprising: one or more memory devices that store a set of instructions; and one or more processors that execute the set of instructions to: acquire, from first data, first text data relating to text included in the first data, the first data being print data; convert the first data into second data, the second data being raster image data; acquire, from the second data, second text data relating to text included in the second data; and compare the first text data and the second text data using text position information, and inspect whether the second data has an anomaly.

### BACKGROUND OF THE INVENTION

### Field of the Invention

The present invention relates to an information processing apparatus, a method for controlling the same, and a storage medium.

### Description of the Related Art

In digital printing systems in the commercial printing field, a scanner is arranged inline inside the machine of an image forming apparatus, and an anomaly in printed matter is detected from an image obtained by reading the printed matter. When executing anomaly detection, there is a detection method (referred to as RIP detection hereinafter) in which a difference is detected as an anomaly by comparing image data of a bitmap raster image generated in RIP processing and read image data obtained by a scanner. Note that RIP is an abbreviation for raster image processor.

Such RIP detection has the following problems. In a digital printing system, a creator of the print data can also specifically designate the type of font to be used and the like in the print data. However, there are cases where the font designated in the print data cannot be used on the image forming apparatus side, and in such cases, the font is replaced with another font on the image forming apparatus side. In this case, a character after RIP expansion may be changed to a character that the creator does not intend, resulting in a so-called “garbled character” in some cases. Also, it is known that a combination of fonts with transparency effects, special effects, and the like causes problems such as a garbled character, a skipped character, and a missing character.

Bitmap image data after RIP processing may already have character problems such as a garbled character, a skipped character, and a missing character in this manner. Thus, when performing RIP detection on an image read by a scanner, there is a problem that a character problem cannot be detected by comparing the bitmap image data with data obtained after the character problem has occurred. That is, when both the image data generated through RIP processing and the scanned image data have character problems in a similar manner, there is a problem that it may be determined that the data is normal. Japanese Patent Laid-Open No. 2017-121769 proposes a technique for inspecting a garbled character by comparing PDL text data extracted from the print data written in the PDL language before RIP processing is performed, with text data recognized by OCR of bitmap RIP image data after RIP processing is performed.

However, the above conventional technique has the following issues. In the above conventional technique, the extraction order in which PDL text data is extracted from PDL data needs to match the recognition order in which OCR text data is recognized through OCR of the RIP image. Note that PDL is an abbreviation for page-description language, and OCR is an abbreviation for optical character recognition. In a case where the extraction order matches the recognition order, a garbled character can be detected by comparing pieces of character information in order. However, the extraction order of PDL text data does not always match the recognition order of OCR text data recognized through OCR of the RIP image. The above conventional technique does not consider the extraction order and the recognition order, and thus is problematic in that correct inspection cannot be performed in a case where these orders are different from each other.

For example, when creating PDL data from an application such as Notepad or WordPad, PDL drawing commands for text objects are issued regularly from the upper left to the lower right with the upper left used as a reference point. Therefore, the PDL text data to be extracted from PDL data is extracted in a regular text arrangement from the upper left to the lower right with the upper left used as a reference point. On the other hand, when creating PDL data from an application that allows free layout, such as PowerPoint or InDesign, a sequence of PDL drawing commands for text objects to be issued does not have regularity. In such a case, PDL drawing commands are issued in the order in which a user places the text objects. Therefore, the PDL text data to be extracted from PDL data is extracted in an irregular text arrangement depending on the creator.

Also, regarding OCR of a RIP image, generally, text is recognized regularly from the upper left to the lower right with the upper left used as a reference point. In such a case, PDL data created from Notepad and WordPad applications can be compared therewith correctly because the arrangements of text objects match. However, comparison with PDL data having an irregular text arrangement is problematic in that correct comparison cannot be achieved. OCR does not only use the upper left as a reference point, but also recognizes text in consideration of vertical writing, tables, column layouts, and the like, as well as only recognizes a portion including text whose position has been acquired in advance based on RIP processing or image processing information as in the conventional technique. However, any OCR is problematic in that correct comparison cannot be achieved because the arrangement of text objects of the PDL text data extracted from PDL data is not considered.

### SUMMARY OF THE INVENTION

The present invention enables realization of a mechanism for inspecting anomalies of the RIP data even in a case where PDL text data extraction order and OCR text data recognition order differ from each other.

One aspect of the present invention provides an information processing apparatus comprising: one or more memory devices that store a set of instructions; and one or more processors that execute the set of instructions to: acquire, from first data, first text data relating to text included in the first data, the first data being print data; convert the first data into second data, the second data being raster image data; acquire, from the second data, second text data relating to text included in the second data; and compare the first text data and the second text data using text position information, and inspect whether the second data has an anomaly.

Another aspect of the present invention provides a method for controlling an information processing apparatus, comprising: acquiring, from first data, first text data relating to text included in the first data, the first data being print data; converting the first data into second data, the second data being raster image data; acquiring, from the second data, second text data relating to text included in the second data; and comparing the first text data and the second text data using text position information, and inspecting whether the second data has an anomaly.

Still another aspect of the present invention provides a non-transitory computer-readable storage medium storing a computer program for causing a computer to execute each step in a method for controlling an information processing apparatus, the control method including: acquiring, from first data, first text data relating to text included in the first data, the first data being print data; converting the first data into second data, the second data being raster image data; acquiring, from the second data, second text data relating to text included in the second data; and comparing the first text data and the second text data using text position information, and inspecting whether the second data has an anomaly.

Further features of the present invention will be apparent from the following description of exemplary embodiments with reference to the attached drawings.

### BRIEF DESCRIPTION OF THE DRAWINGS

FIG. 1 is a block diagram showing an example of the hardware configuration of an image forming apparatus according to an embodiment.

FIG. 2 is a diagram showing an example of the software configuration of an image forming apparatus according to an embodiment.

FIG. 3 is a flowchart for extracting text data from PDL data and a RIP image and creating a list of text data, according to an embodiment.

FIGS. 4A and 4B1-4B2 are diagrams showing an example of a correspondence relationship between commands and a PDL data drawing content with irregularly arranged text data according to an embodiment.

FIGS. 5A-5C are a diagram showing an example of a list of text data extracted from PDL data according to an embodiment.

FIGS. 6A and 6B1-6B3 are diagrams showing an example of a list of OCR text data of a normal RIP image according to an embodiment.

FIGS. 7A and 7B1-7B3 are diagrams showing an example of a list of OCR text data of a RIP image having a garbled character according to an embodiment.

FIGS. 8A and 8B1-8B3 are diagrams showing an example of a list of OCR text data of a RIP image with a skipped character according to an embodiment.

FIG. 9 is a flowchart showing a flow of text inspection after RIP processing according to an embodiment.

FIG. 10 is a flowchart for searching for OCR text data having coordinate information similar to coordinate information of PDL text data according to an embodiment, and comparing the OCR text and the PDL text.

FIG. 11A to 11C are diagrams showing an example of searching for and comparing text data when OCR text data and PDL text data according to an embodiment match.

FIGS. 12A to 12C are diagrams showing an example of searching for and comparing OCR text data having a garbled character according to an embodiment and PDL text data.

FIGS. 13A and 13B are diagrams showing an example of searching for and comparing OCR text data having a missing character or a skipped character according to an embodiment.

FIG. 14 is a diagram showing an example of consolidating multiple pages into 2-in-1 and performing RIP processing according to an embodiment.

FIG. 15 is a flowchart for extracting text data from PDL data and a RIP image, creating a list of text data, and correcting the list of PDL text data according to edit settings during RIP processing, according to an embodiment.

FIG. 16 is a diagram showing an example of a list of text data extracted from PDL data according to an embodiment.

FIG. 17 is a diagram showing an example of a list of OCR text data of a normal 2-in-1 RIP image according to an embodiment.

FIG. 18 is a diagram showing an example of 2-in-1 correction of a list of PDL text data according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Hardware Configuration

Hereinafter, a first embodiment according to the present invention will be described. In this embodiment, inspection control performed in a case where the extraction order in which PDL text data is extracted from PDL data (print data) differs from the recognition order in which OCR text data is recognized through OCR of a RIP image (raster image data) will be described. In this embodiment, an information processing apparatus described below inspects whether there are any anomalies in the RIP data of correct answer data used in an inspection apparatus that inspects printed matter.

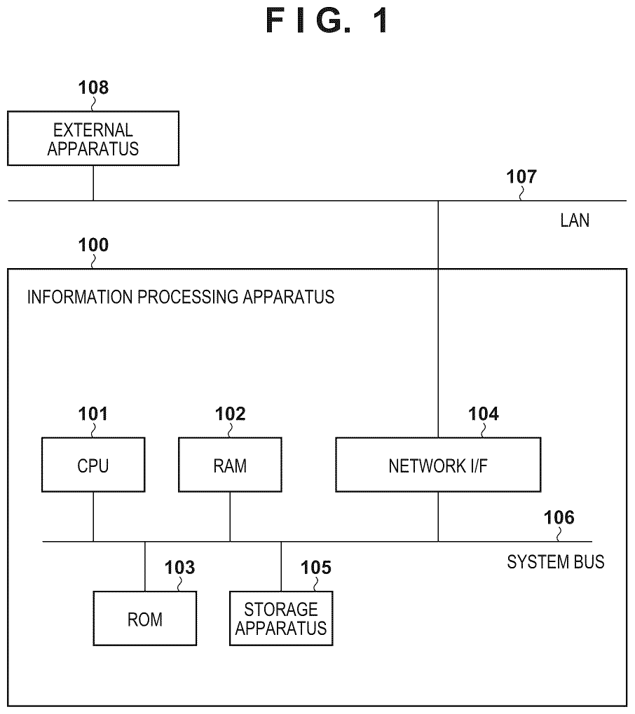

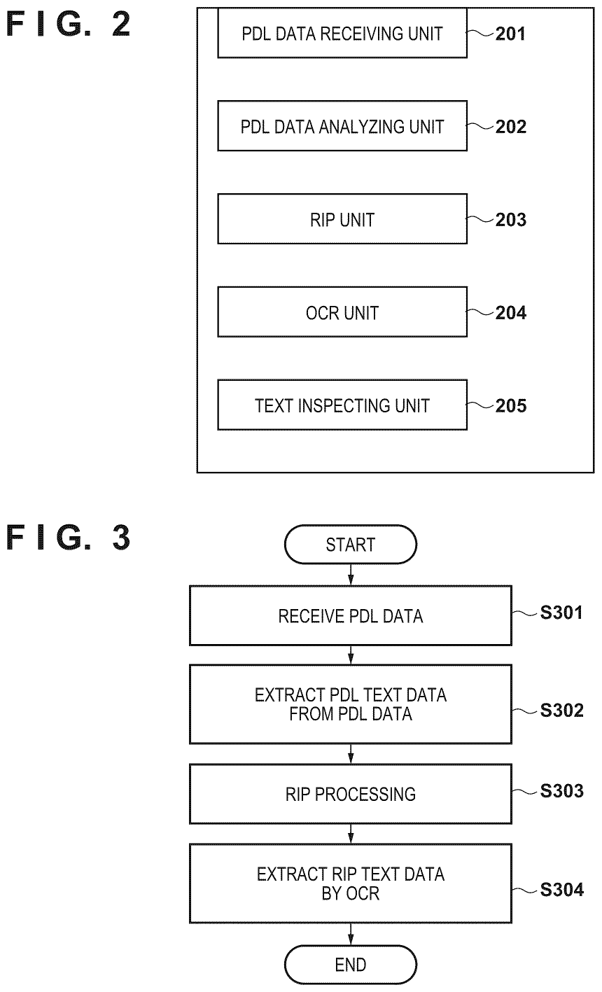

First, an example of the hardware configuration of an information processing apparatus 100 according to an embodiment will be described with reference to FIG. 1. The information processing apparatus 100 includes a CPU 101, a RAM 102, a ROM 103, a network I/F 104, and a storage apparatus 105, which are connected to each other via a system bus 106. The CPU 101 is a central control unit of the information processing apparatus 100. The RAM 102 is a storage device accessible by the CPU 101 and is used as a working memory for the CPU 101 to operate in this embodiment. Programs are stored in the ROM 103, and the CPU 101 loads the programs onto the RAM 102 and executes the programs to operate later-described software modules shown in FIG. 2. The network I/F 104 is connected to an external apparatus 108 (such as a server or another apparatus) via a network (LAN) 107, and is an interface for inputting and outputting information. The storage apparatus 105 is an auxiliary storage apparatus such as an HDD or SSD and is used as a working area of the CPU 101 and for storing data such as documents. Note that it is presumed that documents are acquired from the external apparatus 108 via the network I/F 104 or documents are acquired from the storage apparatus 105 in this embodiment.

In this embodiment, the information processing apparatus will be described as an example of an apparatus to which the present invention is applied. Therefore, the information processing apparatus according to this embodiment inspects whether or not RIP data, which will be correct answer data in the inspection of printed matter, has an anomaly such as a garbled character or a skipped character, and provides the inspection results, and corrected RIP data, and the like to an image forming apparatus or an image processing apparatus that inspects printed matter. However, there is no intention to limit the present invention, and the present invention may be applied to an image processing apparatus provided with at least one of a printer that forms an image on a sheet and a scanner that reads an image from an original. That is, an image processing apparatus, which inspects printed matter, may also inspect RIP data, which will be correct answer data in the inspection of printed matter.

### Software Configuration

Next, an example of the software configuration of the information processing apparatus 100 according to this embodiment will be described with reference to FIG. 2. As shown in FIG. 2, the information processing apparatus 100 includes, as software modules, a PDL data receiving unit 201, a PDL data analyzing unit 202, a RIP unit 203, an OCR unit 204, and a text inspecting unit 205. Note that in a case where the present invention is applied as an image processing apparatus, a printer unit that controls printing and a scanner unit that controls reading of originals can be further included.

As described above, the CPU 101 executes programs loaded from the ROM 103 onto the RAM 102, and thus these software modules operate. The PDL data receiving unit 201 receives PDL data, which is print data (first data), from an external apparatus such as the external apparatus 108 via a network. The PDL data analyzing unit 202 is an example of first acquiring unit, and analyzes PDL data received by the PDL data receiving unit 201, and acquires PDL text data (first text data) from a drawing command in the PDL data.

The RIP unit 203 is an example of converting unit, and executes so-called RIP processing for expanding the acquired PDL data into a bitmap image with a designated resolution, thereby generating raster image data (second data). The OCR unit 204 is an example of second acquiring unit, and executes OCR processing on the image obtained through RIP processing, and generates OCR text data (second text data). The text inspecting unit 205 is an example of inspecting unit, and searches for OCR text data (second data) at a corresponding position based on coordinate information of the extracted PDL text data (first data), and inspects text obtained after RIP processing.

### Creation of Text Data

Next, a procedure for creating text data according to this embodiment will be described with reference to FIG. 3. Here, a procedure for extracting text data from the PDL data and the RIP image, and creating lists of text data will be described. Processing described below is realized by, for example, the CPU 101 reading a program stored in the ROM 103 or the storage apparatus 105 into the RAM 102 and executing the program.

### PDL Text Data

First, in step S301, the PDL data receiving unit 201 receives PDL data via the network I/F 104. Then, in step S302, the PDL data analyzing unit 202 extracts PDL text data from the received PDL data, and creates a list of PDL text data for each page.

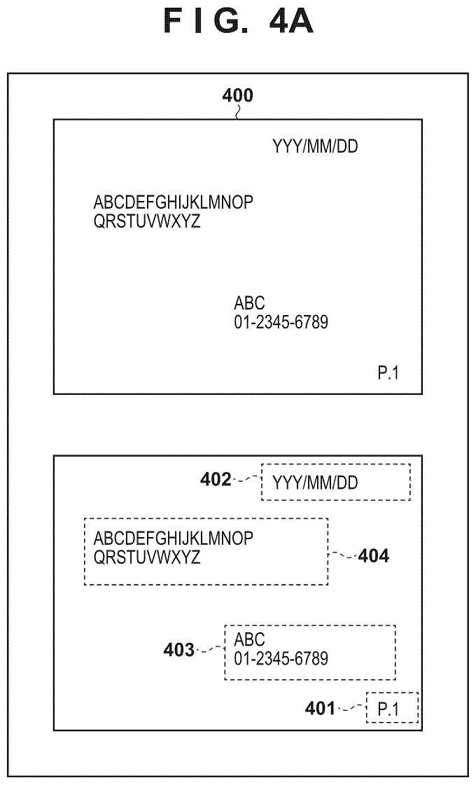

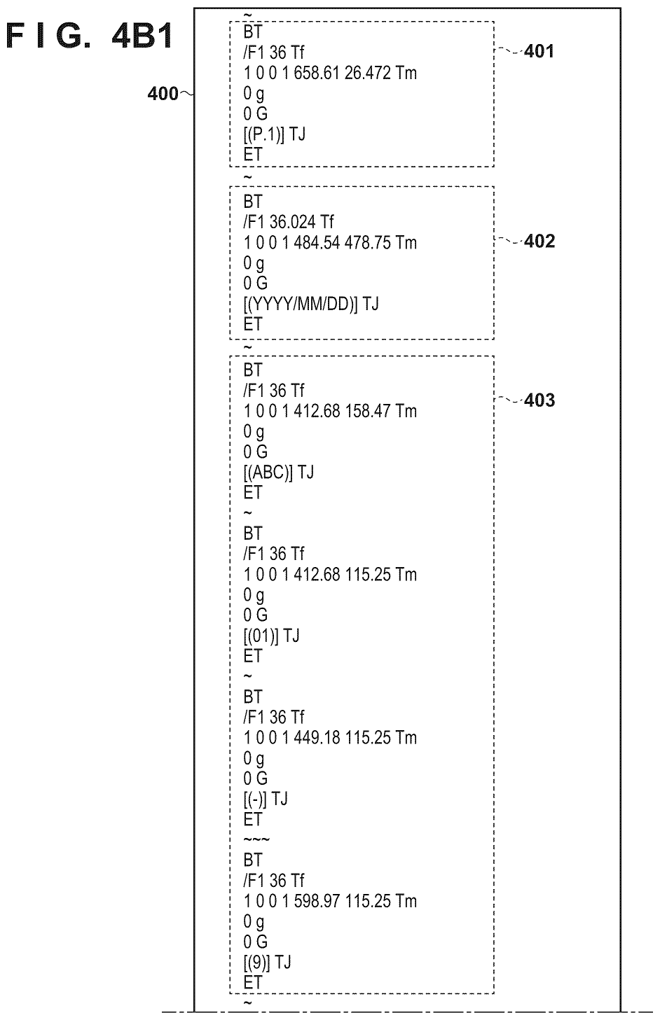

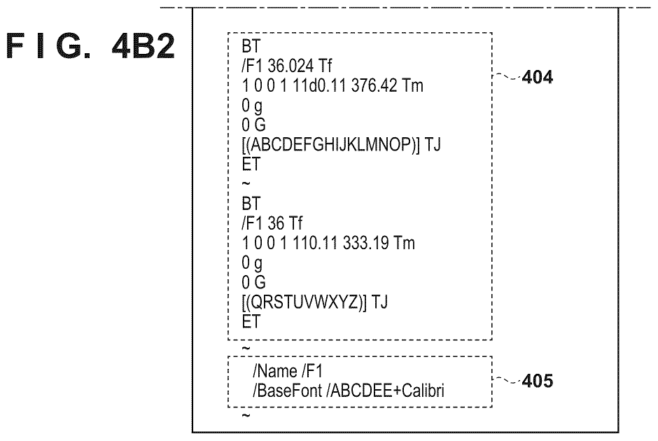

Here, an example in which a list of PDL text data is created from PDL data of a predetermined page will be described with reference to FIGS. 4A-4B2 and 5A-5C. FIG. 4A shows an example of a PDF document, which is a type of PDL, PDL data 400 in FIG. 4A showing drawing contents, and PDL data 400 in FIGS. 4B1-4B2 showing PDL drawing commands corresponding to the drawing contents. When performing drawing, text objects are drawn in the order of PDL drawing commands 401, 402, 403, and 404 in accordance with instructions of the PDL drawing commands 401 to 404 shown in FIGS. 4B1-4B2. Symbols included in the PDL drawing commands 401 to 404 have the following meanings: “BT” indicates the start of drawing a text object, “Tf” indicates a font resource name and a font size, “Tm” indicates a start position of the text object, “g” indicates a gray value used to fill the inside of the text object, “G” indicates the gray value of the contour of the text object, “TJ” indicates the content of text to be displayed, and “ET” indicates the end of drawing the text object. The font actually used is defined in font information referenced from the font resource name.

For example, the PDL drawing command 401 references font resource: /F1, acquires font information 405, and draws a text object “P.1” with font: Calibri, font size: 36 pt, and start position: (x, y)=(658.61, 26.472), using black for filling and as the contour color. Similarly, the PDL drawing commands 402 to 404 are interpreted, and drawing is performed. PDF is used as an example in this embodiment, but other PDL types such as LIPSLX and PCL6 may also be used.

The PDL data analyzing unit 202 analyzes the PDL drawing commands 401 to 404 in the PDL data 400 in the stated order. More specifically, the PDL data analyzing unit 202 breaks down a text object into text data for each character for each command, and extracts information regarding a character, font, coordinates of a rectangular region (“bbox” hereinafter) surrounding the character, and a color value.

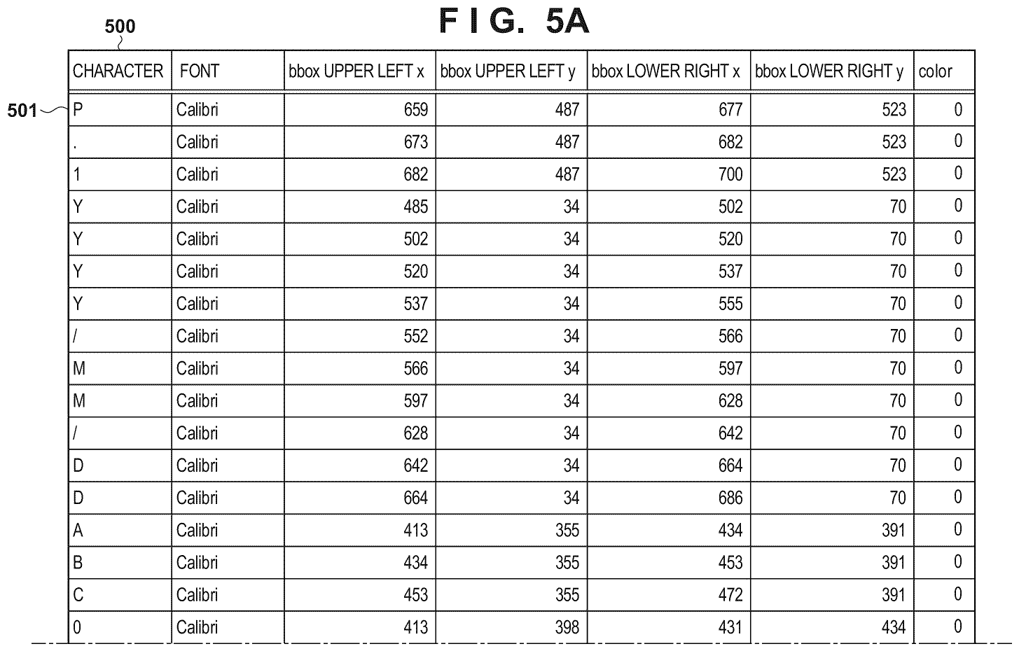

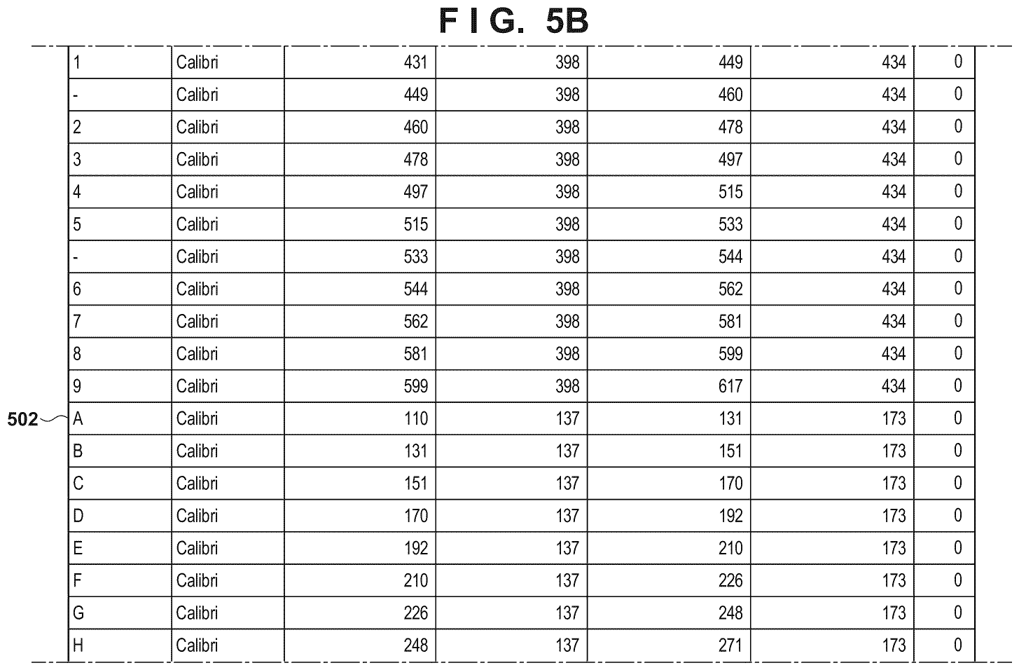

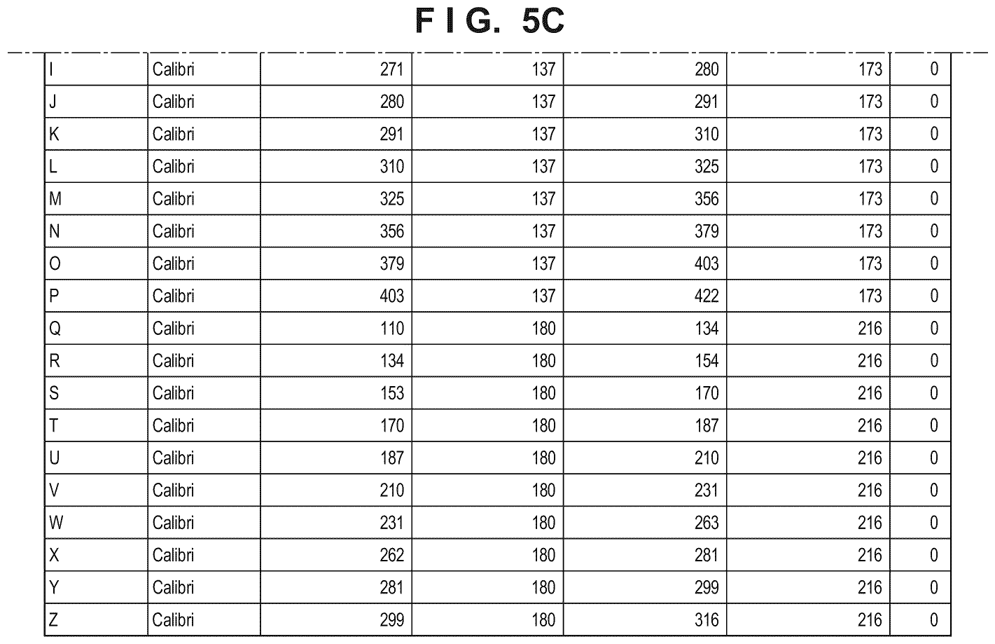

FIGS. 5A-5C show a list of text data obtained by extracting text data for each character from the PDL data 400 shown in FIG. 4. Reference numeral 500 shown in FIGS. 5A-5C indicate the entire list of the PDL text data. For example, text data 501 is information extracted by interpreting the PDL drawing command 401, and indicates the following:
character: “P”,
font: Calibri,
bbox coordinates: (659, 487, 677, 523), and
color: 0 (black).

Also, text data 502 is information extracted by interpreting the PDL drawing command 404, and indicates the following:
character: “A”,
font: Calibri,
bbox coordinates: (110, 137, 131, 173), and
color: 0 (black). It can be seen that sets of text data that are respectively extracted according to the PDL drawing commands 401 to 404 are listed in the stated order in the PDL text data list 500.

### OCR Text Data

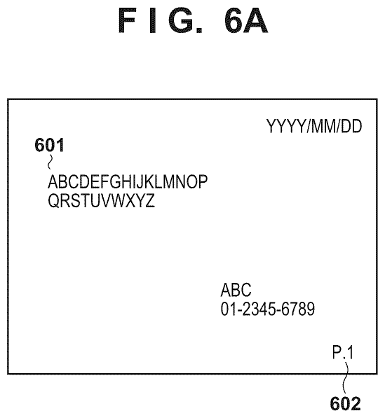

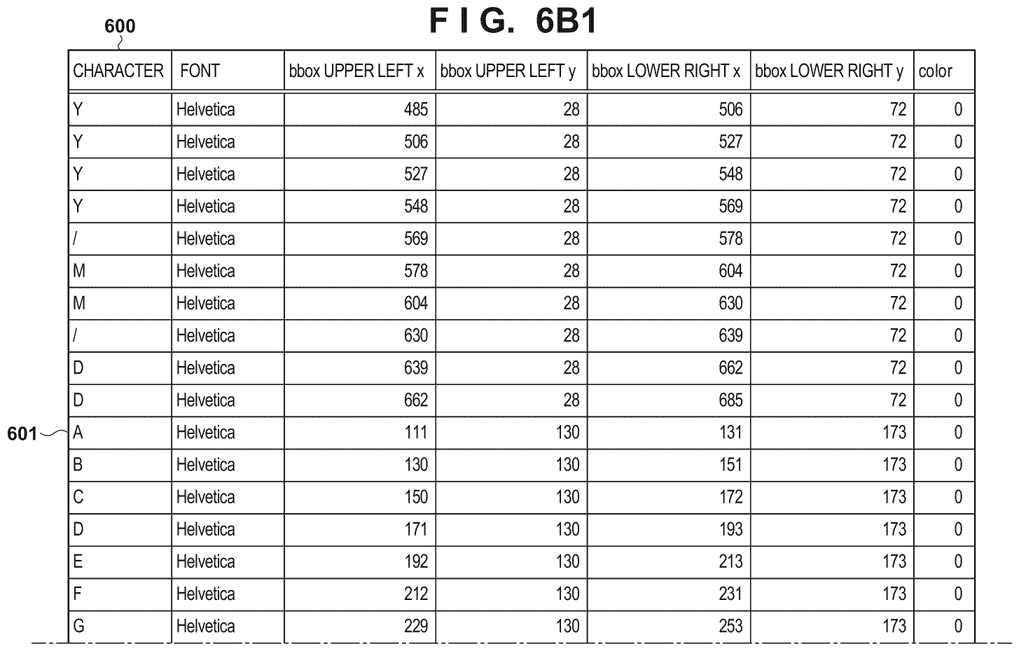

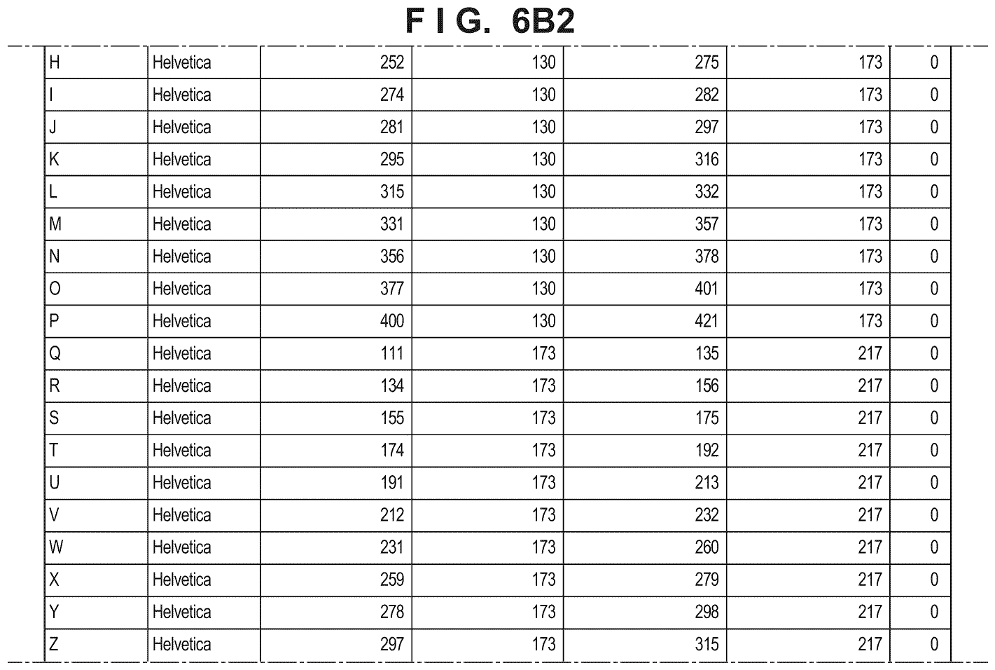

Here, returning to a description of FIG. 3, in step S303, the RIP unit 203 expands the acquired PDL data into a bitmap image with a designated resolution, and creates a RIP image. In step S304, the OCR unit 204 executes OCR processing for each RIP image, creates a list of OCR text data, and ends processing of this flowchart. Here, an example of the OCR text data list will be described using FIGS. 6A to 8B3.

FIGS. 6B1-6B3 show an example of an OCR text data list created from the RIP image in a case where RIP processing can be properly performed on the PDL data 400. FIG. 6A shows a RIP image in a case where RIP processing can be properly performed, and reference numeral 600 in FIGS. 6B1-6B3 indicates the entire list of OCR text data. FIGS. 6B1-6B3 show an example in which sets of text data are listed in the order in which the text data is recognized from the upper left to the lower right with the upper left used as a reference point when performing OCR processing. For example, character 601 in FIG. 6A corresponds to OCR text data recognized by reference numeral 601 in FIGS. 6B1-6B3. Therefore, it can be seen that the text data is recognized from the upper left to the lower right, and “A” in the OCR text data 601 is recognized after “YYYY/MM/DD”. Similarly to the PDL text data, information of the OCR text data 601 includes information regarding a character, font, bbox coordinates, and a color value such as
character: “A”,
font: Calibri,
bbox coordinates: (110, 130, 131, 173), and
color: 0 (black).

Also, reference numeral 602 in FIG. 6A corresponds to OCR text data recognized by reference numeral 602 in FIGS. 6B1-6B3. It can be seen that the order of the OCR text data list 600 differs from that of the PDL text data list 500 in this manner. Regarding the method for recognition in the OCR processing, an example is given in which text data is recognized from the upper left to the lower right with the upper left used as a reference point, but the method is not limited to this. It is possible to use a method for recognize text in consideration of vertical writing, tables, column layouts, and the like or a method for acquiring the position of text in advance and recognizing only the position of text based on RIP processing or image processing information.

### Data in Case of Garbled Character

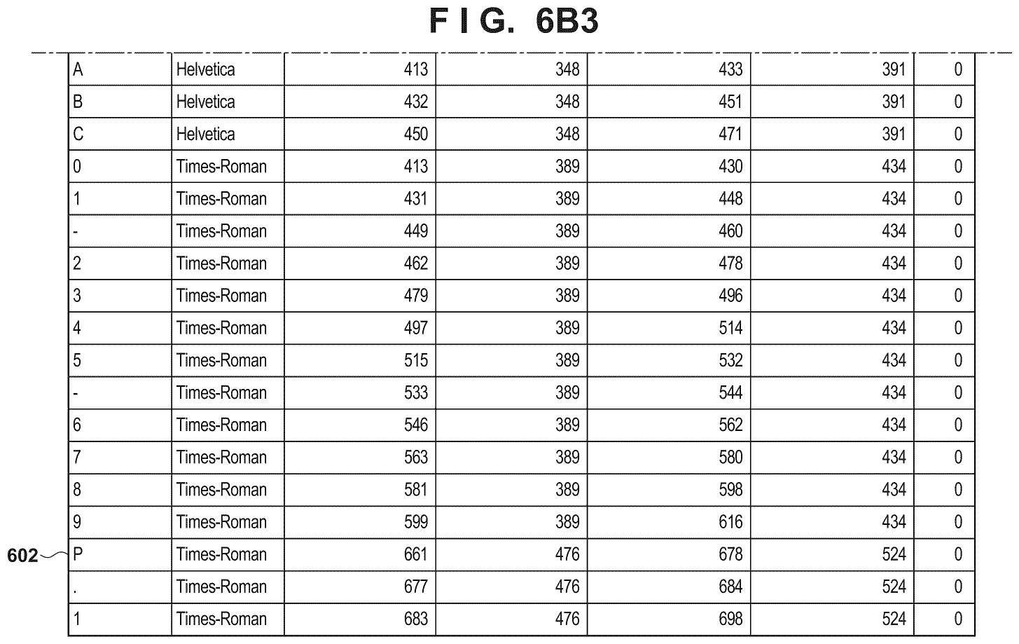

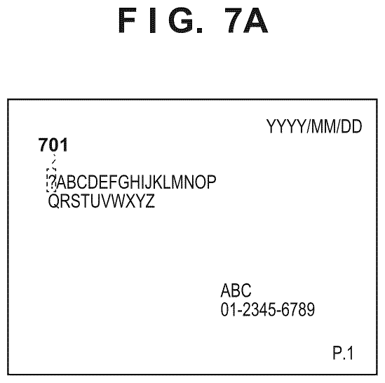

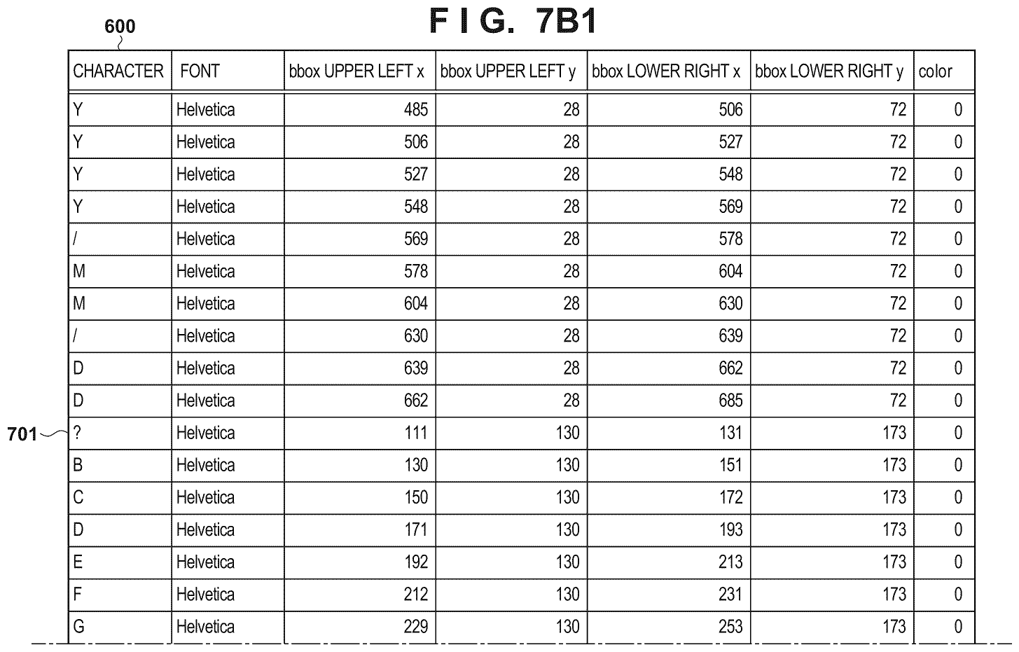

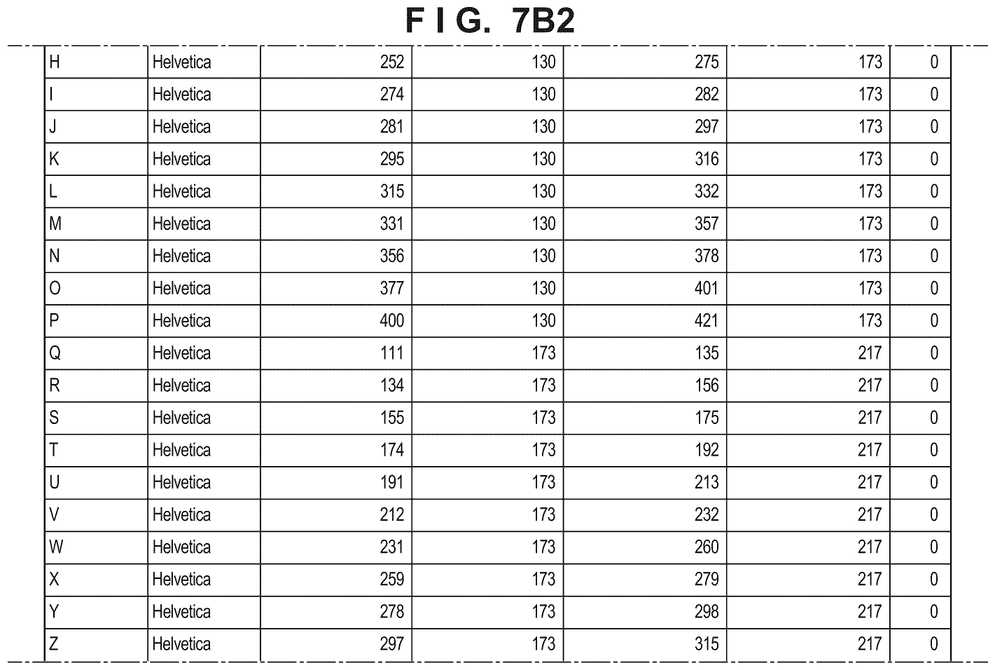

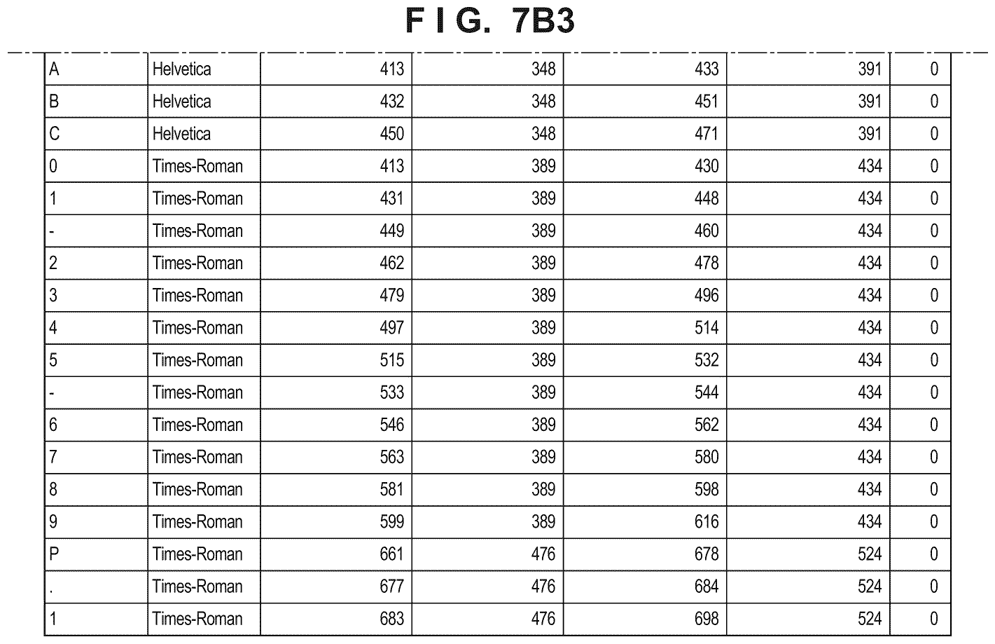

FIGS. 7B1-7B3 are an example of an OCR text data list created from a RIP image having a character garbled when PDL data 400 is subjected to RIP processing. FIG. 7A shows a RIP image including a garbled character, and reference numeral 700 in FIGS. 7B1-7B3 indicates the entire list of OCR text data. In FIG. 7A, “A” as a character 601 in FIG. 6A has been replaced with “?” as a character 701. On the other hand, in FIGS. 7B1-7B3, it can be seen that the garbled character 701 is also included in the OCR text data list 700 created from the RIP image.

### Data in Case of Skipped Character

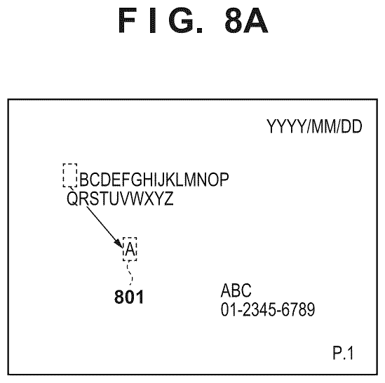

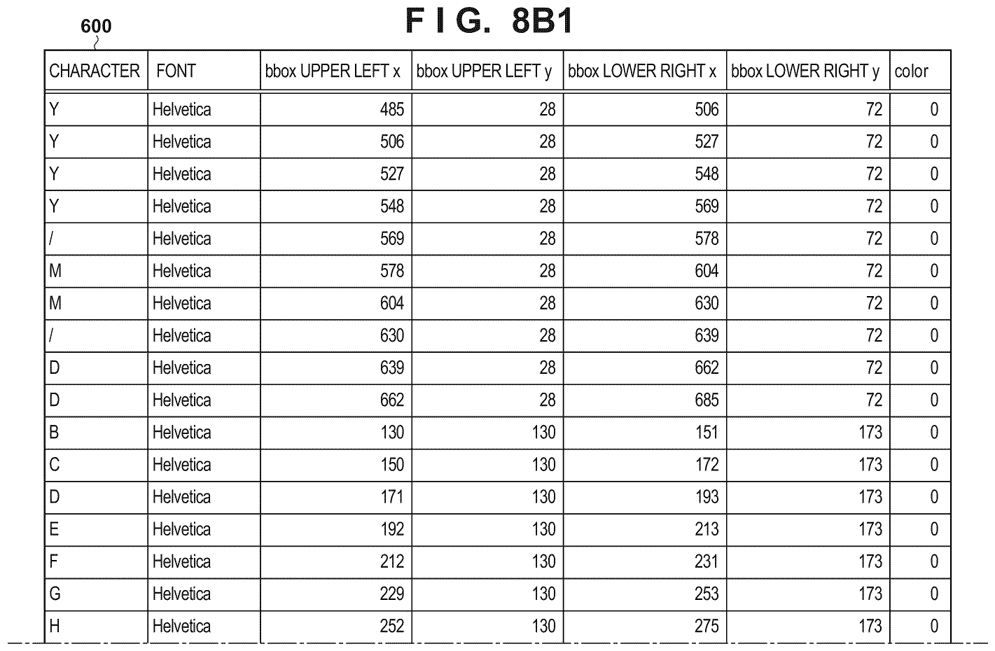

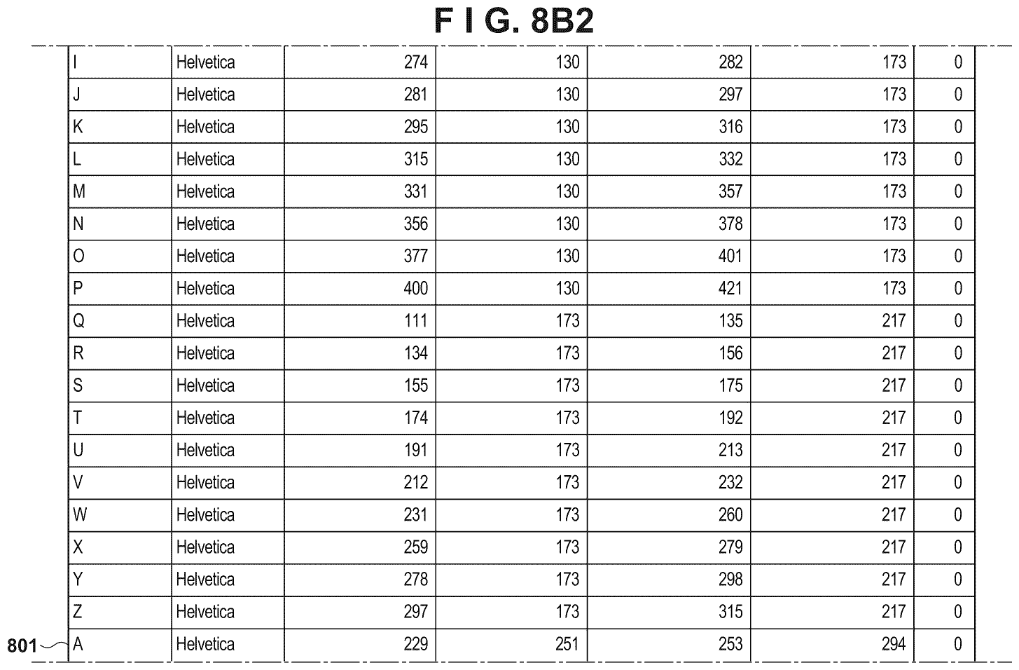

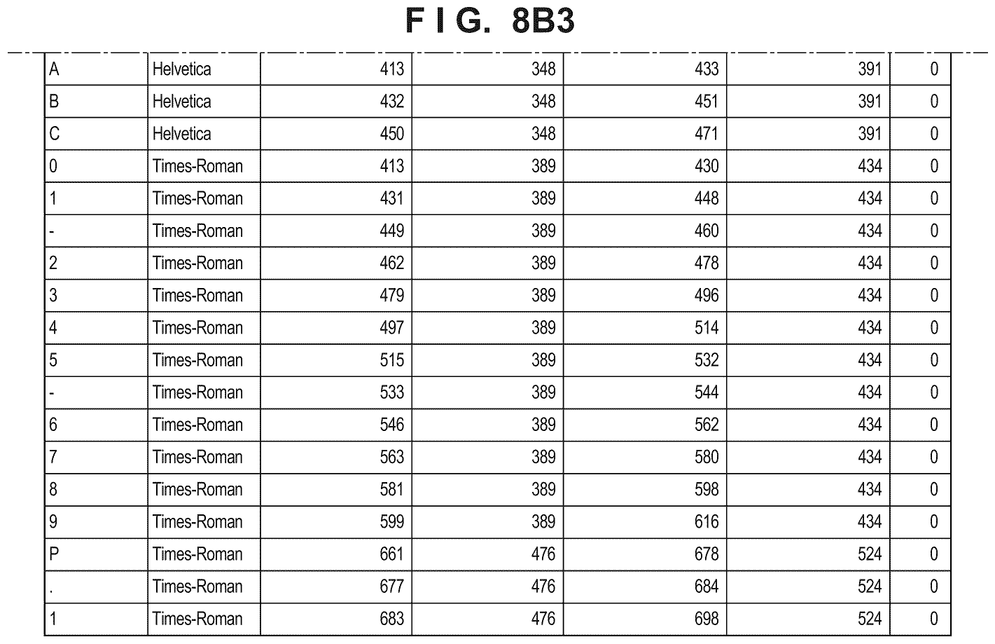

FIGS. 8B1-8B3 are an example of an OCR text data list created from a RIP image having a skipped character when PDL data 400 is subjected to RIP processing. FIG. 8A shows a RIP image including a skipped character, and reference numeral 800 in FIGS. 8B1-8B3 indicates the entire list of OCR text data. FIG. 8A shows that “A” as the character 601 in FIG. 6A has skipped to the position of “A” as a character 801. On the other hand, in FIGS. 8B1-8B3, it can be seen that the character 801 is positioned after character “Z” in the OCR text data list 800 created from the RIP image, and the character skip is still included.

When a garbled character or a skipped character occurs during RIP processing in this manner, these anomalies will be reflected as they are in the OCR text data list created from the RIP image. Therefore, even when printed matter is inspected using these sets of data as correct answer data, there is a problem that the correct answer data may include an anomaly and thus inspection cannot be performed properly. In view of this, in this embodiment, even when an anomaly such as a garbled character or a skipped character occurs in RIP processing as described above, control is provided for accurately inspecting the printed matter. The PDL text data list 500 and the OCR text data lists 600, 700, and 800 each include position information (coordinate information) for each character. The information processing apparatus according to this embodiment suitably inspect printed matter using these pieces of position information. The inspection procedure will be described below in detail.

### Inspection Procedure After RIP Processing

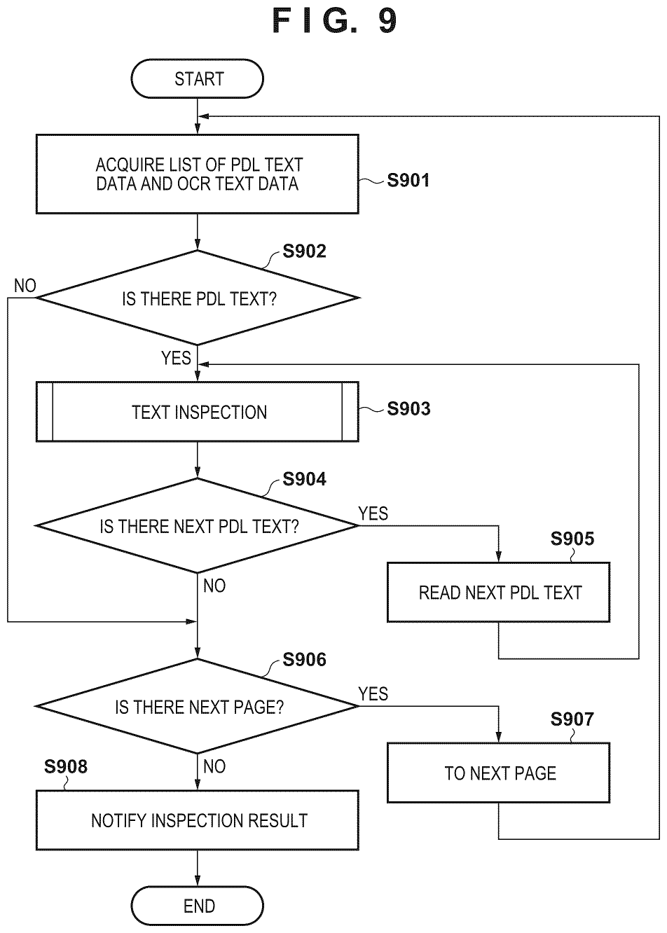

Next, a processing procedure for inspecting text after RIP processing in the information processing apparatus 100 according to this embodiment will be described with reference to FIG. 9. Processing described below is realized by, for example, the CPU 101 reading a program stored in the ROM 103 or the storage apparatus 105 into the RAM 102 and executing the program. Processing from step S901 to step S908 is processing that the CPU 101 causes the text inspecting unit 205 to execute.

In step S901, the text inspecting unit 205 acquires the list of PDL text data and the list of OCR text data for each page created as shown in FIG. 3. Specifically, the text inspecting unit 205 acquires these lists by reading data that has been created in advance in accordance with the flowchart shown in FIG. 3 and stored in a memory or the like. Note that the list data created by an external apparatus may be acquired by receiving the data via a network.

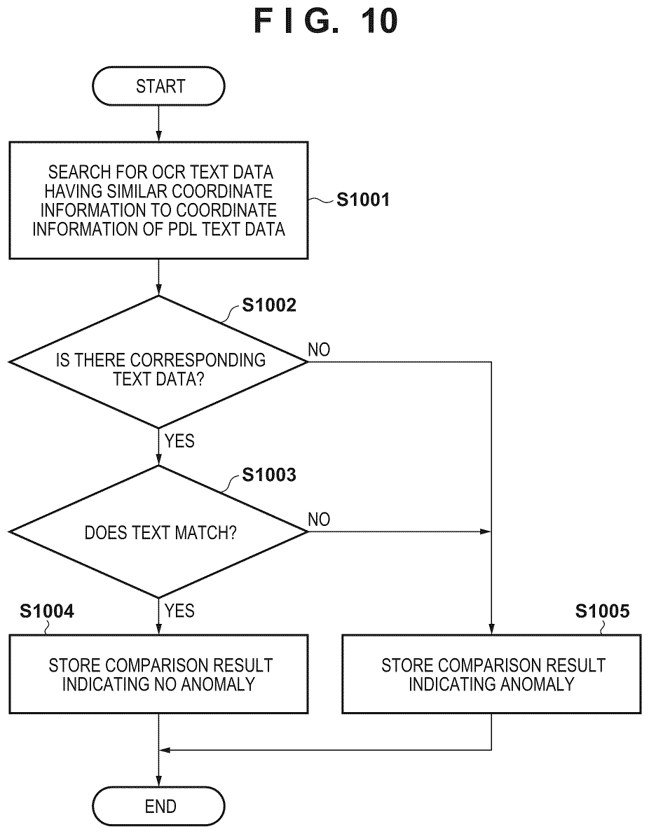

Then, in step S902, the text inspecting unit 205 determines whether or not there is text data to be read from the PDL text data list. In a case where there is text data to be read (YES in step S902), processing proceeds to step S903, whereas in a case where there is no text data to be read (NO in step S902), the processing proceeds to step S906. In step S903, the text inspecting unit 205 performs text inspection based on information of the read PDL text data. Details of text inspection will be described later using FIG. 10. Then, in step S904, the text inspecting unit 205 determines whether or not there is text data to be read next from the PDL text data list. In a case where there is next text data (YES in step S904), processing proceeds to step S905, whereas in a case where there is no next text data (NO in step S904), the processing proceeds to step S906.

In step S905, the text inspecting unit 205 reads the next text data, returns the processing to step S903, and performs text inspection. This is repeated until reading of text data is completed. In step S906, the text inspecting unit 205 determines whether or not there is a next page. In a case where there is a next page (YES in step S906), the text inspecting unit 205 reads the next page in step S907 and returns processing to step S901. That is, processing from step S901 to step S905 is repeated until there is no next page. In a case where all pages are read and there is no next page (NO in step S906), the processing proceeds to step S908. In step S908, the CPU 101 functions as result outputting unit, issues a notification regarding an inspection result, and ends the processing of this flowchart. Here, the inspection result may be displayed on a display unit of the information processing apparatus 100, stored in a storage unit, or transmitted to an external apparatus.

### Details of Text Inspection (step S903)

Next, a detailed processing procedure of text inspection in step S903 shown in FIG. 9 will be described with reference to FIG. 10. Processing described below is realized by, for example, the CPU 101 reading a program stored in the ROM 103 or the storage apparatus 105 into the RAM 102 and executing the program. Processing from step S1001 to step S1005 is processing that the CPU 101 causes the text inspecting unit 205 to execute.

In step S1001, the text inspecting unit 205 uses coordinate information (position information) of the PDL text data for text of interest to search the list of OCR text data for OCR text data having similar coordinate information. In step S1002, the text inspecting unit 205 determines whether or not there is the corresponding OCR text data. In a case where there is the corresponding OCR text data (YES in step S1002), processing proceeds to step S1003, whereas in a case where there is no corresponding text data (NO in step S1002), the processing proceeds to step S1005.

In step S1003, the text inspecting unit 205 compares character information of PDL text data with that of the corresponding OCR text data to determine whether or not they match. In a case where they match (YES in step S1003), processing proceeds to step S1004, whereas in a case where they do not match (NO in step S1003), the processing proceeds to step S1005. In step S1004, the text inspecting unit 205 stores the comparison result indicating that there is no anomaly, and ends the processing of this flowchart. On the other hand, in step S1005, the text inspecting unit 205 stores the result indicating that there is an anomaly, the anomaly content, characters, coordinate information, and the like, and ends the processing of this flowchart.

### Comparison with Normal RIP Image

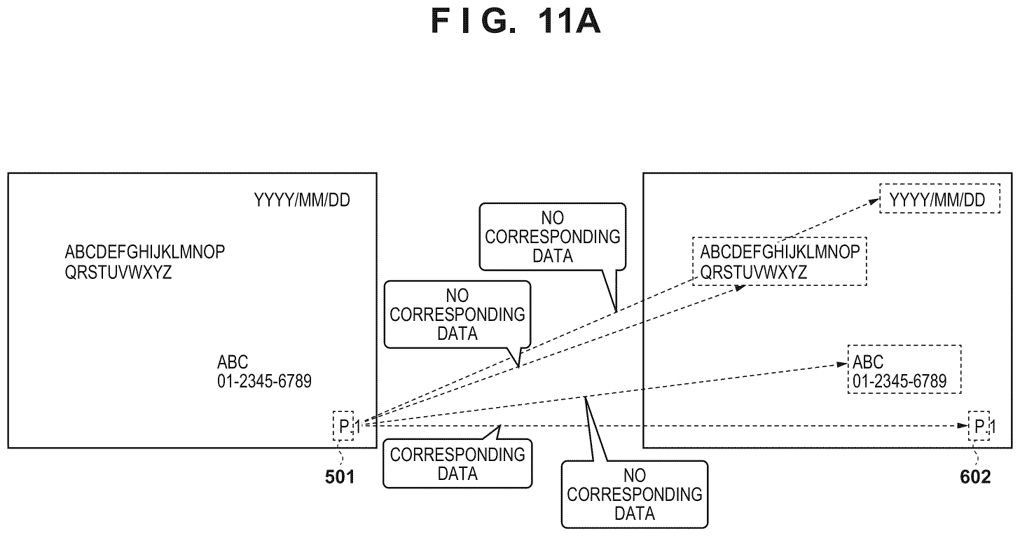

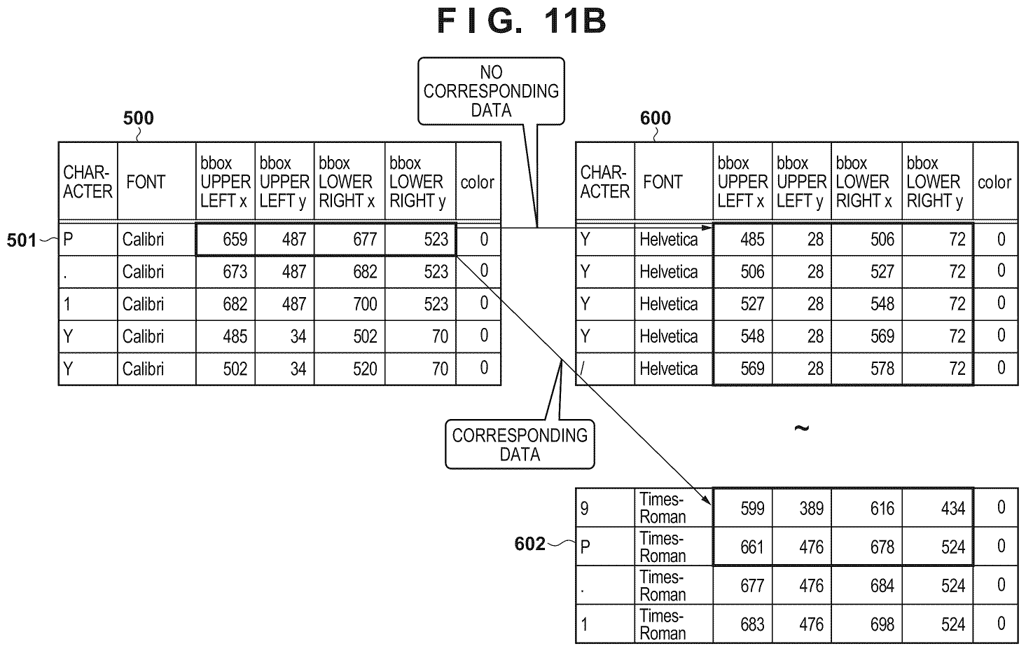

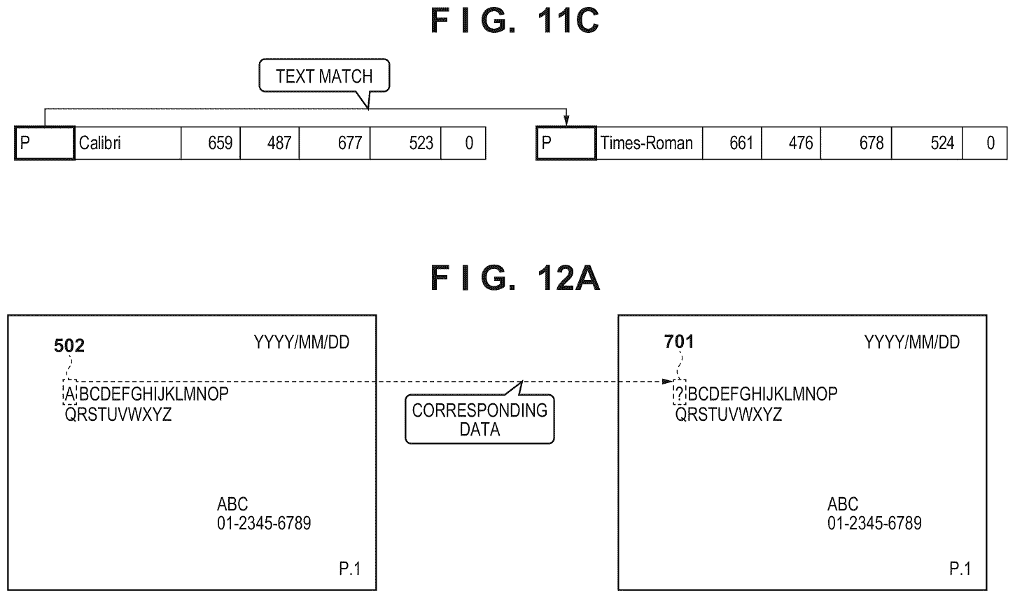

A case where PDL text data is compared with the list of OCR text data of the normal RIP image shown in FIG. 6A will be described with reference to FIG. 11. FIGS. 11A-11C is an image diagram showing that the OCR text data list 600 is searched for OCR text data having similar coordinate information using coordinate information of “P” in the PDL text data 501, and the corresponding OCR text data 602 is found.

FIG. 11B shows actual search processing. In step S1001 above, the text inspecting unit 205 performs a search by sequentially comparing the bbox coordinates (659, 487, 677, 523) of “P” in PDL text data 501 with the bbox coordinates of each set of text data in the OCR text data list 600. Also, in step S1002, the text inspecting unit 205 determines that the bbox coordinates of “P” in PDL text data 501 are similar to the bbox coordinates (661, 476, 678, 524) of “P” in the OCR text data 602 and that the corresponding text data is present (YES in step S1002).

The bbox coordinates of PDL text data extracted from the PDL data do not always match the bbox coordinates of OCR text data recognized through OCR of the RIP image in some cases. Thus, it is desirable that a tolerance is set and a determination with some ambiguity is made rather than a perfect match. For example, although the bbox coordinates of the PDL text data 501 and the bbox coordinates of OCR text data 602 do not perfectly match, in a case where the coordinate positions overlap each other and errors in width and height (i.e., position errors) are less than predetermined thresholds, it is determined that the coordinates are similar to each other. A method for making a determination with some ambiguity is not limited to this.

FIG. 11C shows a comparison between two pieces of character information of two sets of text data. In step S1003, the text inspecting unit 205 compares character information of PDL text data 501 with that of the OCR text data 602, and because character information of the PDL text data 501 and character information of the OCR text data 602 are both “P”, it is determined that they match (YES in step S1003). In this embodiment, only character information is used to determine whether the PDL text data match the OCR text data. However, a method for determining whether they match by combining other parameters such as a color value may also be used. Also, in a case where a plurality of pieces of corresponding text that are within the tolerance in step S1002, when any pieces of character information in the plurality of pieces of text match in step S1003, it may be determined that there is no anomaly. In step S1004, the text inspecting unit 205 stores the inspection result and the comparison result indicating that there is no anomaly. A comparison between the PDL text data list 500 and the OCR text data list 600 reveals that all the sets of text data have no anomaly, and thus a notification regarding a result indicating that there is no anomaly is issued in step S908.

### Comparison with RIP Image including Garbled Character

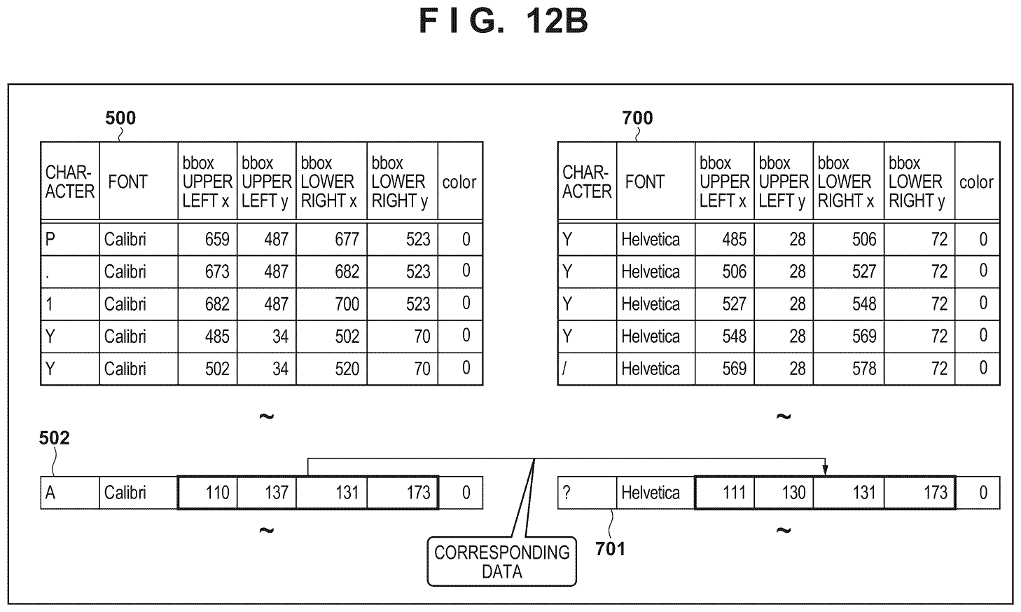

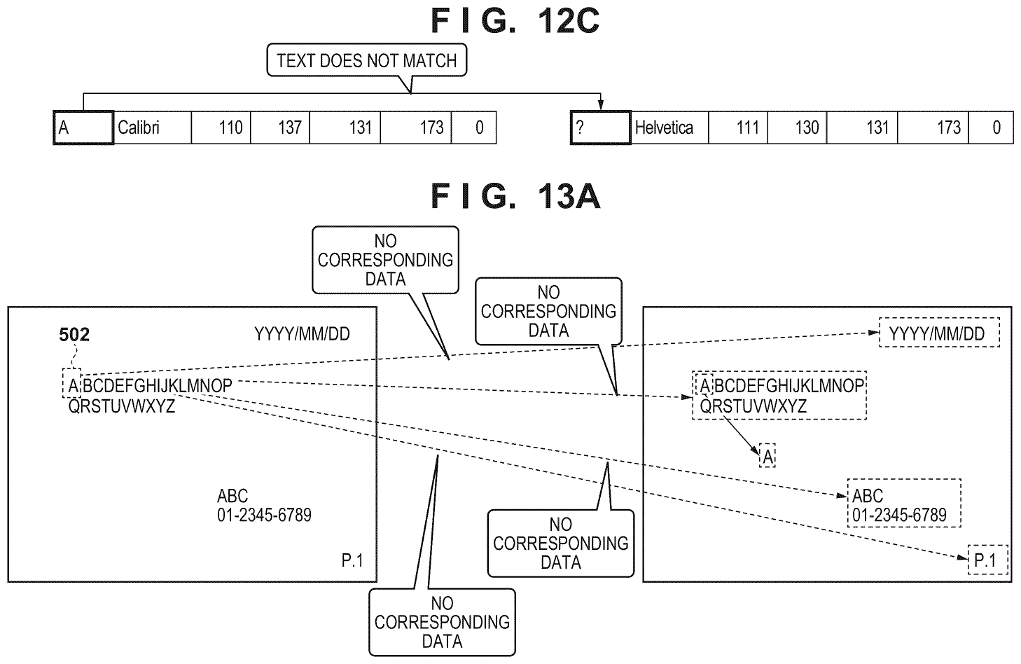

A case where PDL text data is compared with a list of OCR text data of a RIP image including a garbled character shown in FIG. 7A will be described with reference to FIGS. 12A-12C. FIG. 12A is an image diagram showing that the OCR text data list 700 is searched for OCR text data having similar coordinate information using coordinate information of “A” in the PDL text data 502, and the corresponding OCR text data 701 is found.

FIG. 12B shows actual search processing. In step S1001 above, the text inspecting unit 205 performs a search by sequentially comparing the bbox coordinates (110, 137, 131, 173) of “A” in PDL text data 502 with the bbox coordinates of text data in the OCR text data list 700. In step S1002, the text inspecting unit 205 determines that the bbox coordinates of “A” in the PDL text data 502 are similar to the bbox coordinates (111, 130, 131, 173) of “?” in the OCR text data 701 and that the corresponding text data is present (YES in step S1002).

FIG. 12C shows a comparison between two pieces of character information of two sets of text data. In step S1003, the text inspecting unit 205 compares character information of PDL text data 502 with that of the OCR text data 701, and because “A”≠“?” holds true, it is determined that they do not match (NO in step S1003). In step S1005, the text inspecting unit 205 stores the inspection result and the comparison result indicating that there is an anomaly such as a garbled character. Because an anomaly is found in the comparison between the PDL text data list 500 and the OCR text data list 700, a notification regarding a result indicating that there is an anomaly is issued in step S908.

### Comparison with RIP Image including Skipped Character

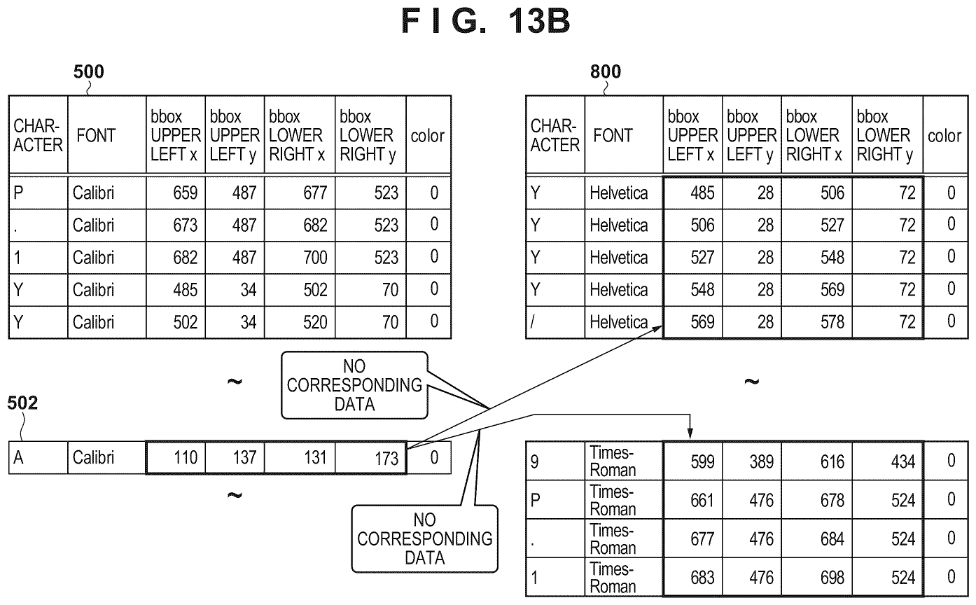

A case where PDL text data is compared with a list of OCR text data of a RIP image including a skipped character shown in FIG. 8A will be described with reference to FIGS. 13A-13B. FIG. 13A is an image diagram showing that the OCR text data list 800 is searched for OCR text data having similar coordinate information using coordinate information of “A” in the PDL text data 502 and there is no corresponding OCR text data.

FIG. 13B shows actual search processing. In step S1001 above, the text inspecting unit 205 performs a search by sequentially comparing the bbox coordinates (110, 137, 131, 173) of “A” in PDL text data 502 with the bbox coordinates of text data in the OCR text data list 700. In step S1002, the text inspecting unit 205 does not find OCR text data having similar coordinates, and determines that there is no corresponding text data (NO in step S1002). In step S1005, the text inspecting unit 205 stores the inspection result and the comparison result indicating that there is an anomaly such as a missing character or a skipped character. Because an anomaly is found in the comparison between the PDL text data list 500 and the OCR text data list 800, a notification regarding a result indicating that there is an anomaly is issued in step S908. Note that if the detected anomaly is correctable, control may be performed to correct the detected anomaly. In such a case, it is desirable to output the correction content together with the result.

As described above, the information processing apparatus according to this embodiment acquires, from PDL data, which is print data, PDL text data regarding text included in the PDL data, and converts the PDL data into RIP data, which is raster image data. Also, the information processing apparatus acquires, from RIP data, OCR text data regarding text included in the RIP data, compares the PDL text data and the OCR text data using text position information, and inspects whether RIP data has an anomaly. Also, the information processing apparatus performs text inspection by searching for OCR text data at a corresponding position using coordinate information (position information) of the PDL text data. Therefore, even when the extraction order in which PDL text data is extracted from PDL data differs from the recognition order in which OCR text data is recognized through OCR of the RIP image, a garbled character occurring after RIP processing can be inspected. Further, it is possible to inspect not only garbled characters but also character problems such as missing characters or skipped characters. As described above, according to this embodiment, it is possible to inspect anomalies of the RIP data even in a case where PDL text data extraction order and OCR text data recognition order differ from each other.

### Second Embodiment

Hereinafter, a second embodiment according to the present invention will be described using the drawings. In this embodiment, a text comparison performed in a case where editing is performed on PDL data during RIP processing will be described as an example. Note that the configuration of the information processing apparatus according to this embodiment is similar to that of the above-described first embodiment shown in FIG. 1. Hereinafter, a difference between the first embodiment and the second embodiment will be mainly described.

### Editing during RIP Processing

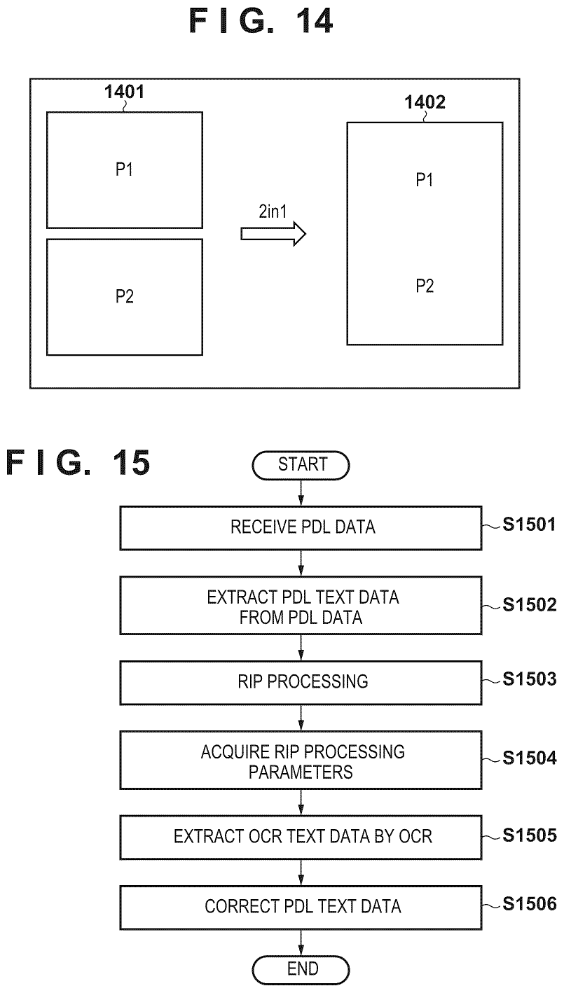

First, an example in which editing is performed on PDL data during RIP processing will be described with reference to FIG. 14. As shown in FIG. 14, there may be a case where PDL data 1401 divided into two pages is subjected to RIP processing with a setting for consolidation into 2-in-1, and one-page RIP image 1402 consolidated into 2-in-1 is created.

### Creation of Text Data

Next, a procedure for creating text data according to this embodiment will be described with reference to FIG. 15. Here, a procedure for extracting text data from PDL data and a RIP image, creating lists of the text data, and correcting the PDL text data list in accordance with editing settings during RIP processing is described. Processing described below is realized by, for example, the CPU 101 reading a program stored in the ROM 103 or the storage apparatus 105 into the RAM 102 and executing the program.

First, in step S1501, the PDL data receiving unit 201 receives PDL data via the network I/F 104. Then, in step S1502, the PDL data analyzing unit 202 extracts PDL text data from the received PDL data, and creates a list of PDL text data for each page.

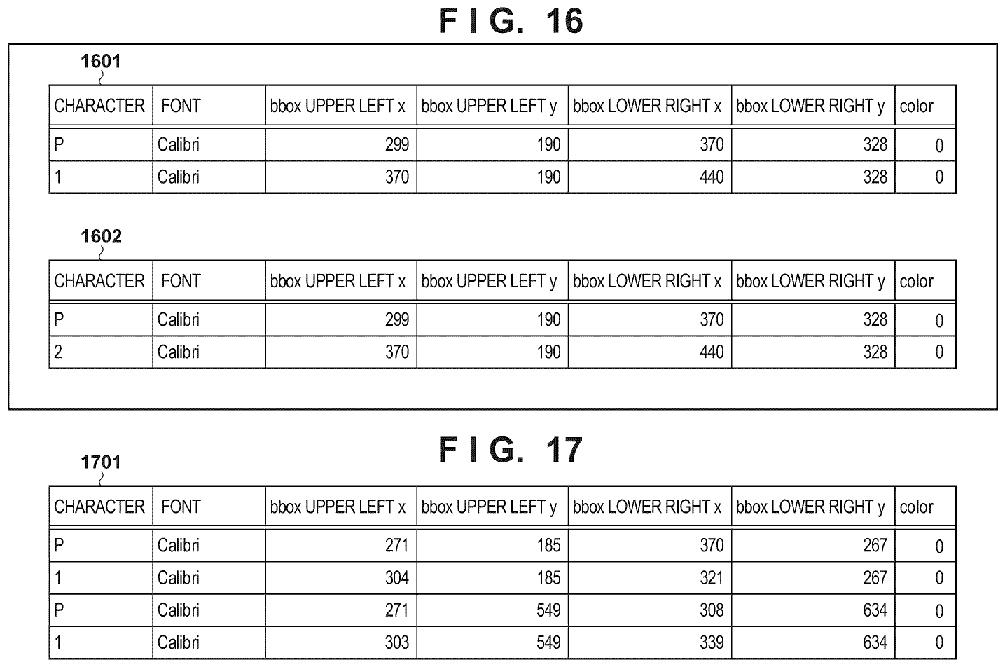

Here, a list of PDL text data for each page will be described with reference to FIG. 16. Regarding the list of extracted PDL text data, reference numeral 1601 indicates a PDL text data list for the first page. Reference numeral 1602 indicates the PDL text data list for the second page. It can be seen that at a stage when PDL text data is extracted from PDL data, the data is divided into two sets of PDL text data in this manner.

In step S1503, the RIP unit 203 expands the acquired PDL data into a bitmap image according to a designated resolution and edit settings, and creates a RIP image. In step S1504, the RIP unit 203 acquires RIP processing parameters according to the edit settings. In the edit settings, it is possible to set the paper size, paper orientation, page consolidation, and the like. The RIP unit 203 performs conversion such as page consolidation, rotation, enlargement/contraction on the acquired PDL data in accordance with the edit settings to create a RIP image. Here, a RIP image consolidated into 2-in-1 is created. Thus, the RIP processing parameters indicate the contents of the edit settings, and are, for example, values indicating 2-in-1 in a case where the edit processing is page consolidation.

Then, in step S1505, the OCR unit 204 executes OCR processing for each RIP image, and creates a list of OCR text data. FIG. 17 shows an example of the list of OCR text data. FIG. 17 shows an example of an OCR text data list created from the RIP image 1402 in a case where 2-in-1 processing is applied to the PDL data 1401 and RIP processing can be properly performed thereon.

Because 2-in-1 processing is performed, only one OCR text data list is created. Because the PDL text data list created from the original PDL data is divided into two and the OCR text data list has been subjected to edit processing to one, it is not possible to compare pieces of coordinate information and inspect text.

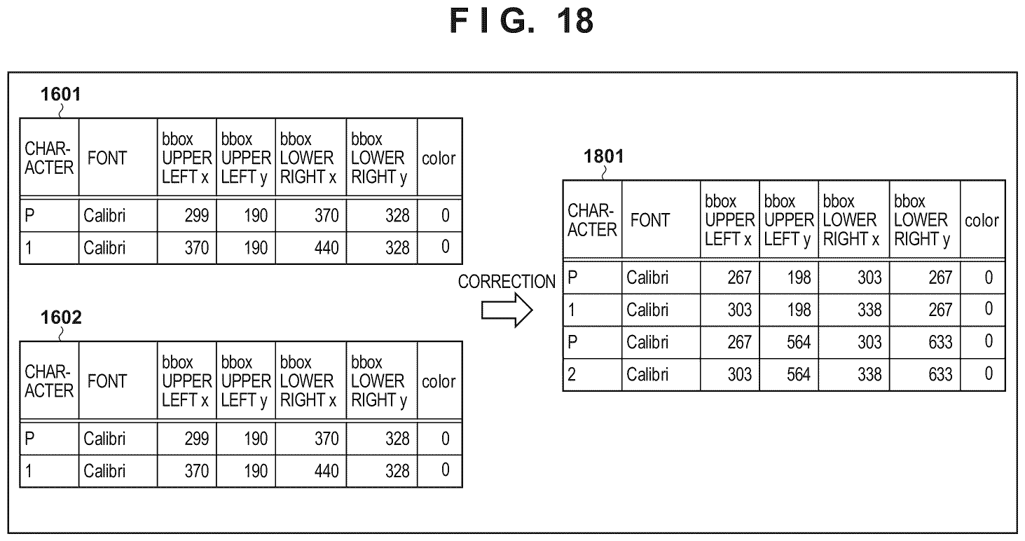

In view of this, in step S1506, the text inspecting unit 205 converts the PDL text data list using the RIP processing parameter acquired in step S1504, and creates a corrected PDL text data list. FIG. 18 shows a PDL text data list 1801 created by correcting the PDL text data lists 1601 and 1602. The correction method may be a method for performing correction and comparing sets of text data when inspecting one character in the text data. Also, the correction method may be a method for performing inverse conversion using a RIP processing parameter on the OCR text data list and performing correction.

As described above, in the information processing apparatus according to this embodiment, PDL data is edited in accordance with print settings and then converted into RIP data, and the acquired PDL text data is further corrected in accordance with parameters involved in the editing. Further, the information processing apparatus acquires OCR text data from the RIP data in accordance with the parameters involved in the editing. In this embodiment, in a case where editing is performed on the PDL data during RIP processing, the PDL text data is corrected in consideration of the RIP processing parameter in this manner. As a result, even when editing is performed on the PDL data during RIP processing, it is possible to compare and inspect the PDL text data and the OCR text data, and to inspect character problems such as garbled characters, missing characters, and skipped characters. Therefore, according to this embodiment, even when the PDL data is edited in accordance with print settings during RIP processing, it is possible to obtain effects similar to those of the first embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139122, filed Aug. 29, 2023, which is hereby incorporated by reference herein in its entirety.

What is claimed is:

1. An information processing apparatus comprising:
one or more memory devices that store a set of instructions; and
one or more processors that execute the set of instructions to:
acquire, from first data, first text data relating to text included in the first data, the first data being print data;
convert the first data into second data, the second data being raster image data;
acquire, from the second data, second text data relating to text included in the second data; and
compare the first text data and the second text data using text position information, and inspect whether the second data has an anomaly.

2. The information processing apparatus according to claim 1, wherein
the one or more processors execute instructions in the one or more memory devices to:
store the inspection result in a storage unit; and
display the inspection result on a display unit.

3. The information processing apparatus according to claim 2, wherein
the one or more processors execute instructions in the one or more memory devices to:
transmit the inspection result to an external apparatus.

4. The information processing apparatus according to claim 1, wherein
the one or more processors execute instructions in the one or more memory devices to:
search the second text data for text data having position information similar to position information of text of interest, for each text included in the first text data; and
determine, when text data having position information similar to position information of the text of interest is found from the second text data, whether or not the text of the first text data and the corresponding text of the second text data match.

5. The information processing apparatus according to claim 4, wherein
the one or more processors execute instructions in the one or more memory devices to:
determine that the second data has an anomaly in a case where the text of the first text data and the corresponding text of the second text data do not match, or in a case where no text data having position information similar to the position information of the text of interest is found from the second text data.

6. The information processing apparatus according to claim 5, wherein
the text data having position information similar to the position information of the text of interest is text data included in the second text data having position information with error less than a predetermined threshold from the position information.

7. The information processing apparatus according to claim 6, wherein
the position information is coordinate information.

8. The information processing apparatus according to claim 4, wherein
the one or more processors execute instructions in the one or more memory devices to:
edit the first data in accordance with a print setting and convert the edited first data into the second data;
further correct the acquired first text data in accordance with a parameter involved in the editing; and
acquire the second text data from the second data in accordance with a parameter involved in the editing.

9. The information processing apparatus according to claim 8, wherein
the editing includes page consolidation and image processing of rotation, enlargement, and contraction of an image according to a paper size and a paper orientation.

10. The information processing apparatus according to claim 4, further comprising:
a printer that forms an image on a sheet; and
a scanner that reads an image from an original,
wherein the information processing apparatus is an image processing apparatus.

11. A method for controlling an information processing apparatus, comprising:
acquiring, from first data, first text data relating to text included in the first data, the first data being print data;
converting the first data into second data, the second data being raster image data;
acquiring, from the second data, second text data relating to text included in the second data; and
comparing the first text data and the second text data using text position information, and inspecting whether the second data has an anomaly.

12. A non-transitory computer-readable storage medium storing a computer program for causing a computer to execute each step in a method for controlling an information processing apparatus, the control method including:
acquiring, from first data, first text data relating to text included in the first data, the first data being print data;
converting the first data into second data, the second data being raster image data;
acquiring, from the second data, second text data relating to text included in the second data; and
comparing the first text data and the second text data using text position information, and inspecting whether the second data has an anomaly.
